(19) United States
(12) Patent Application Publication
(10) Pub. No.: US 2020/0223462 A1
(43) Pub. Date: Jul. 16, 2020

(54) FOLDING SUPPORT RAIL AND TONGUE FOR CONVERTING A HAND TRUCK, CART OR DOLLY INTO TO A PANEL CART

(71) Applicant: Edwin Howard Ferree, JR., Asheville, NC (US)

(72) Inventor: Edwin Howard Ferree, JR., Asheville, NC (US)

(21) Appl. No.: 16/189,957

(22) Filed: Nov. 13, 2018

Related U.S. Application Data
(60) Provisional application No. 62/707,610, filed on Nov. 10, 2017.

(51) Int. Cl. B62B 3/02; B62B 5/06

(52) U.S. Cl. CPC B62B 3/02; B62B 5/06

(57) ABSTRACT

Methods and apparatus improve the panel support rail, tongue, handle and hinge system for hand-trucks, carts and dollies that convert to panel-carts. A panel-cart, typically seen in large building supply stores, is used to carry plywood panels, windows, door and other similar object as well as long lumber, all of which cannot be carry by a standard hand-truck. The conversion efficiency of a hand-truck to a panel-cart is improved and the user complexity reduced, partially by attaching parts with hinges that were previously separate components, further by using the handle as a primary or secondary support rail when placed in the extended position via hinges or fixed receivers.

### CROSS-REFERENCE TO RELATED APPLICATIONS

This application claims the benefit of priority of U.S. provisional application No. 62/707,610, filed Nov. 10, 2017, the contents of which are herein incorporated by reference.

### BACKGROUND OF THE INVENTION

### 1. Field of the Invention

The present invention relates to tools for assisting a user in moving items and, more particularly, to a folding support rail and tongue for converting a hand truck, cart, dolly, or the like, into a panel cart.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The use of a wheeled cart, by one person, to transport a large variety of different sized and shaped objects, such as long lumber, plywood panels, mattresses, doors, windows, garment bags, large boxes, crates or furniture through doorways or down narrow hallways, requires the use of several different types of wheeled carts, such as a hand truck, a panel cart, a hand cart, a hotel cart or a dolly. For most users, it would be impractical because of the expense and/or storage space required to own three or four carts. A standard hand truck or multi-use cart cannot be converted into a panel cart, most often used at building supply stores, to carry plywood, doors and long lumber.

Since plywood panels, mattresses, doors, windows and similar items must be turned on their edge to be transported through doorways, through gate openings or down narrow hallways, a standard hand truck will not work for that purpose. Loading several sheets of plywood on a standard hand truck is only possible by placing the load across the tongue and perpendicular to the direction of travel, making the load too wide to transport through a standard door. A dolly can haul long objects through a doorway, but it would not work to haul panels, a mattress, or a window on their edge because it has no center support to lean the items against. Laying items flat on a dolly would again make the load too wide. The panel cart has a center support system to allow material to be stood up on its edge and is therefore the only type of cart to perform these functions.

The particular hand-truck/panel-cart referred in FIG. 1 thru FIG. 8, as disclosed in U.S. Pat. No. 8,820,773, the contents of which are herein incorporated by reference, uses a folding support rail that can be extended from the body of the device to create a fixed rail whereas objects such as plywood panels or tall stacks of long lumber are leaned against it for support. Also, this particular hand truck uses a tongue that can be removed from the end of the hand truck by releasing two spring clips and reinstalled into the side of the hand truck.

The folding rail system of the hand truck referred to above, as shown in FIGS. 5, 6 and 7, uses two separate rails on either end of the cart that are extended to the open position and then connected by a separate rail. Since there are several moving parts that need to be rotated then attached to each other, as well as a separate detachable rail, the existing folding support rail system is somewhat time consuming and complicated for the first-time user.

The movable tongue system of the hand truck referred to above, as shown in FIGS. 3 and 4, uses a system of rails to slide out of the larger rails located in the end of the hand truck frame, thereby detaching it from its position and allowing it to be repositioned into the side of the hand truck. Since it is a separate detachable part that requires the user to align the tongue rails for insertion into the receiver rails and to use spring clips to be used in the conversion, the existing tongue repositioning system is somewhat time consuming and complicated for the first-time user.

The handle of the hand truck referred to above can be repositioned to be used as a secondary support rail to hold material via a 90-degree bracket made of tubing that needs to be installed prior to inserting the handle. Since there are several of these loose parts that need to be repositioned prior to inserting the handle, it can be complicated and time consuming for the user.

As it can be seen, there is a need for a folding support rail and movable tongue system to decrease the time required to convert the hand truck into a panel cart. There is also a need to use fewer separate detachable component parts to make it less complicated to operate for the first-time user.

### SUMMARY OF THE INVENTION

The present invention relates generally to a folding support rail system and movable tongue of a hand truck that converts into a panel cart, such as that described in U.S. Pat. No. 8,820,773, as shown in FIG. 1 thru FIG. 8. Further, the present invention relates to any hand truck, cart or dolly for conversion to a panel cart.

In one aspect of the present invention, a folding support rail system comprises of an upper support rail 7, connected to two 0 to 90-degree link hinges 3 located on opposing ends that are connected to each of the center support rails 13 which are then connected to each of two 0 to 180-degree link hinges 4 which are then connected to two lower support rails 12 which have a lower section of rails attached at 90 degrees that rotate around the main pivoting hinge rails 1. When the system is in the closed position the assembly rests in the two under carriage cradles 5. When the system is in the open position the two sliding handle connector rails 15 slide from position on the center support rails 13 half of their length to partially cover the two lower support rails 12 thereby locking the two rails in a 180 position.

In another aspect of the present invention, the handle 9 of the hand-truck can be inserted into receivers allowing it to be used as the primary or secondary panel support rail.

In yet another embodiment of the present invention the hand-truck tongue 2, pivots 90 degrees into position as required for a panel-cart.

Embodiments of the present invention provide a convertible cart comprising a main frame defining a main frame perimeter and a main frame plane, the main frame plane defining a lengthwise direction and a widthwise direction; a set of main wheels extending at least a portion below the main frame plane; and a cradle extending below the main frame plane; a vertical support rail system disposed in the cradle when the convertible cart is in a hand cart configuration, wherein the vertical support rail system is configured to be lifted from the cradle to extend above the main frame plane when the convertible cart is in a panel cart configuration.

Embodiments of the present invention further provide a convertible cart comprising a main frame defining a main frame perimeter and a main frame plane, the main frame plane defining a lengthwise direction and a widthwise direction; a set of main wheels extending at least a portion below the main frame plane; a cradle extending below the main frame plane; a vertical support rail system disposed in the cradle when the convertible cart is in a hand cart configuration; and a tongue member, wherein the tongue member is convertible between the hand cart configuration, wherein the tongue member extends along the widthwise direction of the main frame, and the panel cart configuration, wherein the tongue member extends along the lengthwise direction of the main frame, wherein the vertical support rail system is configured to be lifted from the cradle to extend above the main frame plane when the convertible cart is in a panel cart configuration, and the vertical support rail system is a single, fully integrated component of the convertible cart.

Embodiments of the present invention also provide a convertible cart comprising a main frame defining a main frame perimeter and a main frame plane, the main frame plane defining a lengthwise direction and a widthwise direction; a set of main wheels extending at least a portion below the main frame plane; a cradle extending below the main frame plane; a vertical support rail system disposed in the cradle when the convertible cart is in a hand cart configuration; a handle extending from an end of the main frame, the handle having a grip portion extending in the widthwise direction when the convertible cart is in the hand cart configuration; and a tongue member, wherein the tongue member is rotatable about an axis, without separation from the main frame, to convert between the hand cart configuration and the panel cart configuration, wherein, in the hand cart configuration, the tongue member extends along the widthwise direction of the main frame, and the panel cart configuration, the tongue member extends along the lengthwise direction of the main frame, wherein the vertical support rail system is configured to be lifted from the cradle to extend above the main frame plane when the convertible cart is in a panel cart configuration, and the vertical support rail system is a single, fully integrated component of the convertible cart.

Therefore, a general object of the present invention is to provide an improved folding support rail system for the multi-use hand truck that converts to a panel cart.

Another object of the present invention is to provide a folding support rail system that will allow the conversion to be made with one motion.

Yet another object of the present invention is to provide a folding support rail system that will extend to the opened position with one motion.

Still another object of the preset invention is to provide a folding support rail system that will retract to the closed position with one motion.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 thru FIG. 8 are perspective views of a conventional hand truck having a folding support rail showing the progressive steps required to change from hand truck to panel cart;

FIGS. 9A, 9B and 9C are side and cross-sectional views, respectively, of the improved folding support rail system according to an exemplary embodiment of the present invention, in the closed position, having the handle and tongue removed, thus allowing for its use as a dolly;

FIGS. 10A, 10B and 10C are side and cross-sectional views, respectively, of the system of FIG. 9 in the transition position from closed to open;

FIGS. 11A, 11B and 11C are side and cross-sectional views, respectively, of the system of FIG. 9 in the extended position;

FIGS. 12A, 12B and 12C are side and cross-sectional views, respectively, of the folding support rail in the extended and locked position;

FIG. 13 is an expanded view of the system of FIG. 9, according to an exemplary embodiment of present invention, in the closed position more clearly showing the use of link hinges 3 and 4;

FIG. 14 is an expanded view of the system of FIG. 13, in the transition position, more clearly showing the use of the link hinges;

FIG. 15 is an expanded view of the system of FIG. 13 in the extended position;

FIG. 16 is an expanded view of the system of FIG. 13 in the extended and locked position after the sliding support handle 15 has been lowered into position;

FIG. 17 is a top view of the system of FIG. 13 incorporated in to the hand-truck in the closed position;

FIG. 18 is a side view of the system of FIG. 13 incorporated in to the hand-truck in the closed position;

FIG. 19 is a section view of the system of FIG. 13 incorporated in to the hand-truck in the closed position;

FIG. 20 is an end view of the system of FIG. 13 incorporated in to the hand-truck in the closed position;

FIG. 21 thru FIG. 24 are perspective views of embodiments of the present invention showing the transition of the tongue at the end of the hand-truck to the side of the panel-cart;

FIG. 25 thru FIG. 28 are perspective views of embodiments of the present invention showing the transition of the handle at the end of the hand-truck to the center of the panel-cart;

FIG. 29 shows flat plate link hinge components;

FIG. 30 and FIG. 31 show flat plate link hinge assembled;

FIG. 32 shows an exemplary embodiment of a tongue member according to an exemplary embodiment of the present invention;

FIG. 33 is a perspective view of a convertible cart in a hand cart configuration; and

FIG. 34 is a perspective view of the convertible cart of FIG. 33 in a panel cart configuration.

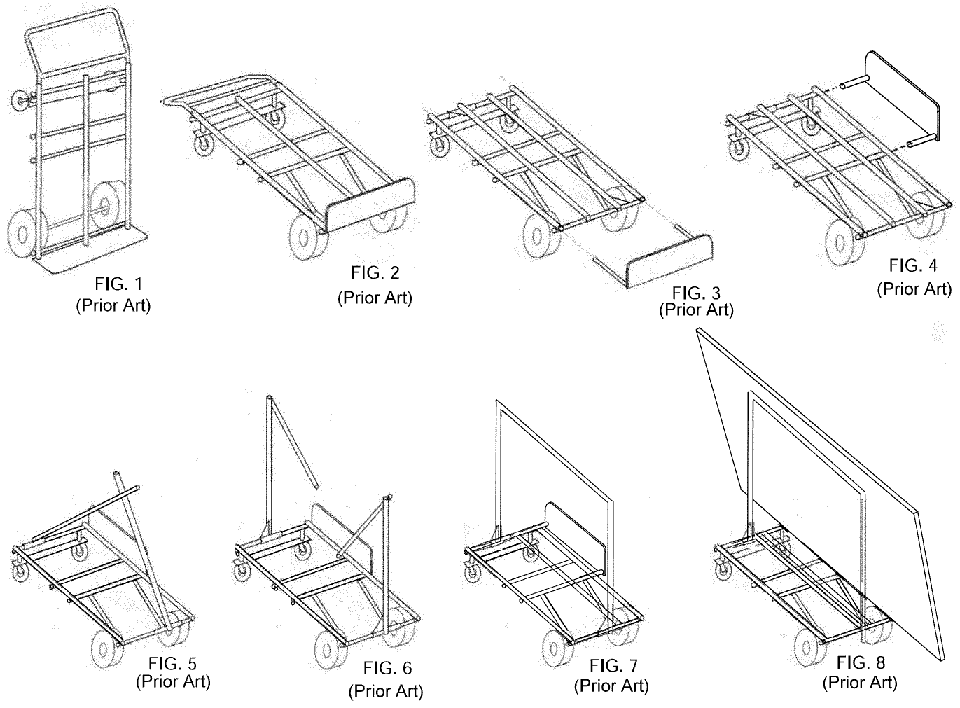

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any apparatus, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide methods and apparatus for improving the panel support rail, tongue, handle and hinge system for hand-trucks, carts and dollies that convert to panel-carts. A panel-cart, typically seen in large building supply stores, is used to carry plywood panels, windows, door and other similar object as well as long lumber, all of which cannot be carry by a standard hand-truck. In certain embodiments of the present invention, the conversion efficiency of a hand-truck to a panel-cart is improved and the user complexity reduced, partially by attaching parts with hinges that were previously separate components, further by using the handle as a primary or secondary support rail when placed in the extended position via hinges or fixed receivers.

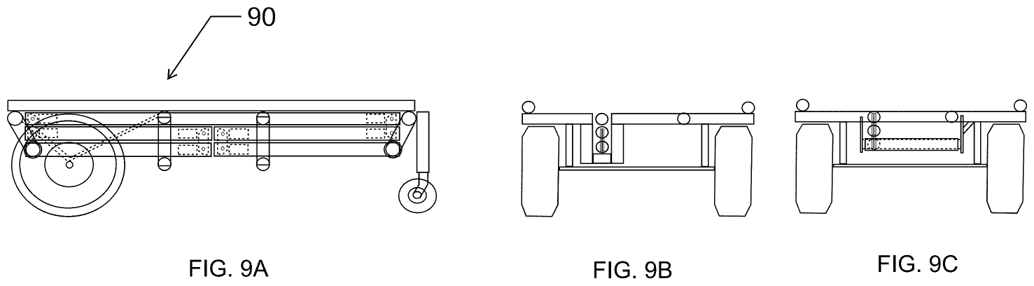

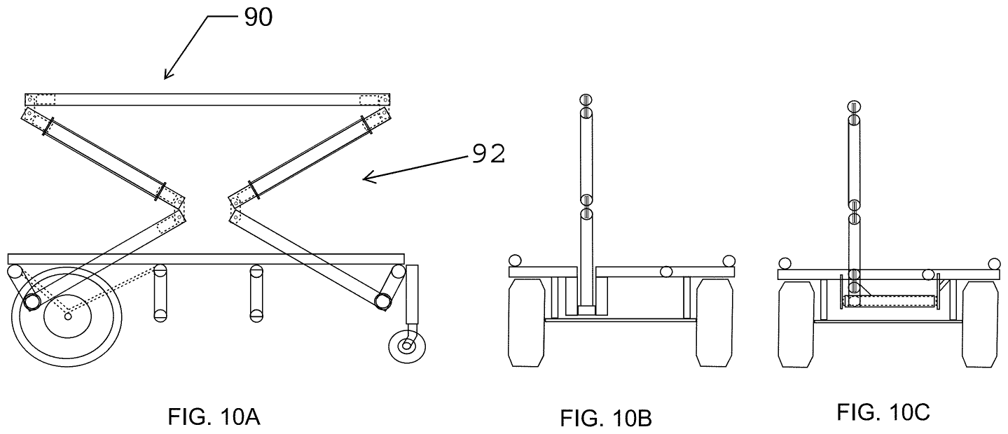

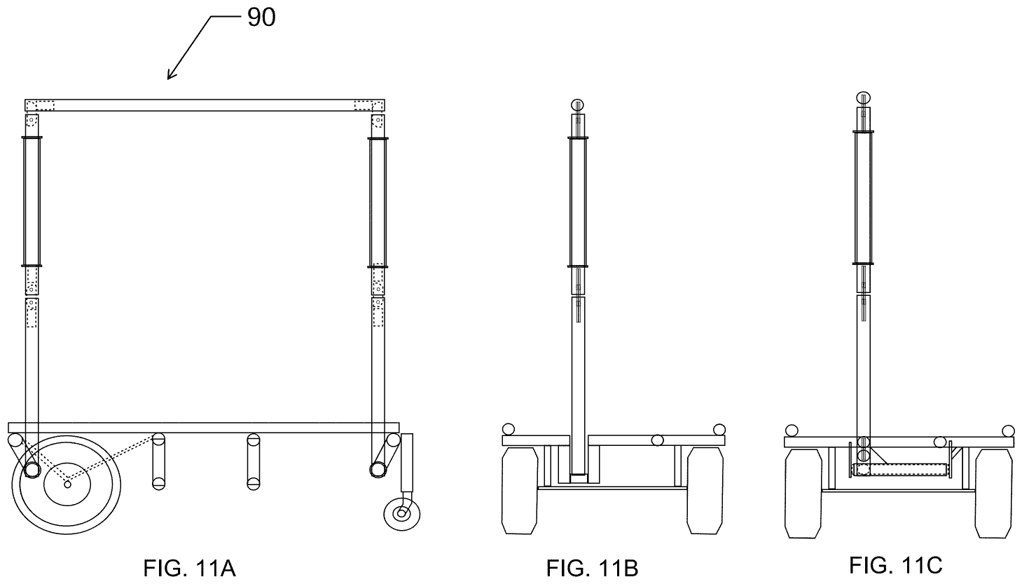

Referring to FIGS. 9 through 20, certain embodiments of the present invention include, but are not limited to, a fully attached hinged support rail system that includes an upper support rail 7, 0 to 90-degree link hinges 3, center support rails 13, 0 to 180-degree link hinges 4, lower support rails 12, sliding handle connector rails 15, and under carriage tube hinges 1.

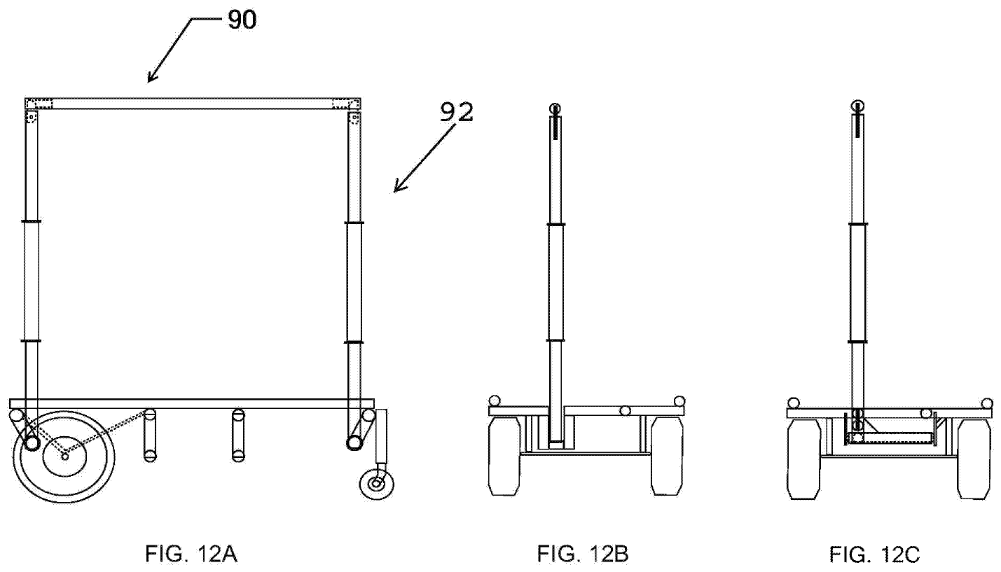

When extending from the horizontal (closed) position, as shown in FIG. 9, to the vertical (open) position, as shown in FIG. 12, or from the vertical position back to the horizontal position, the system can be extended or retracted in a more efficient and user-friendly way than those of conventional convertible systems.

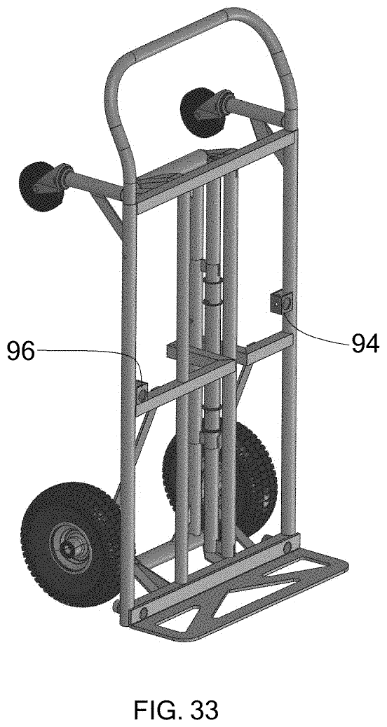

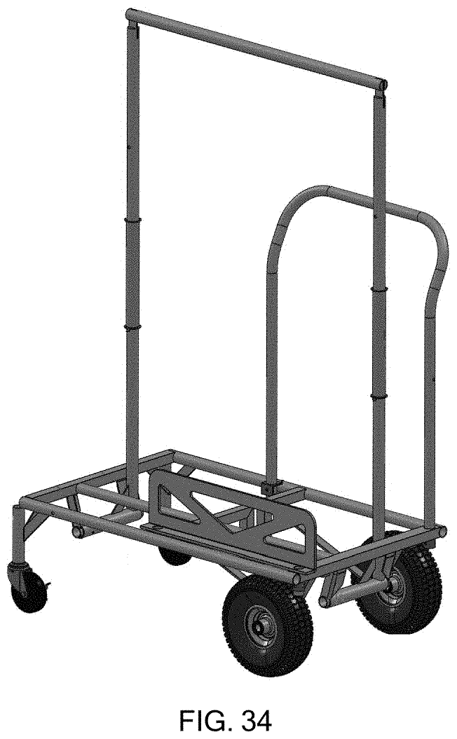

Another embodiment of the present invention includes a receiver in the body of the hand-truck or dolly so that the handle 9 of the hand-truck can be inserted into receivers, allowing it to be used as the primary or secondary panel support rail. The receivers can include the receiver 94 as shown in FIG. 33, for example.

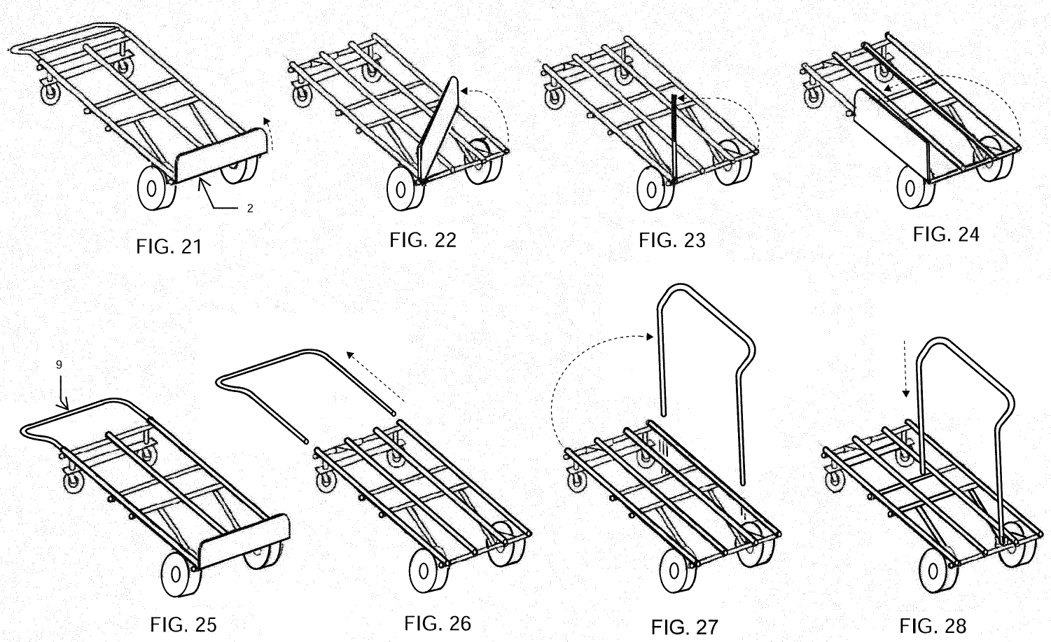

Yet another embodiment of the present invention includes attachment modification of the tongue 2, typically used on hand-trucks to retain materials, to a hinged tongue that pivots 90 degrees into position as a panel-cart, as shown in FIGS. 21 through 24. Pivoting the tongue 2 allows the system to be converted in a more efficient and user-friendly way than conventional systems. The pivoted tongue 2 may include a pin that is received in a receiver, such as receiver 96, as shown in FIG. 33.

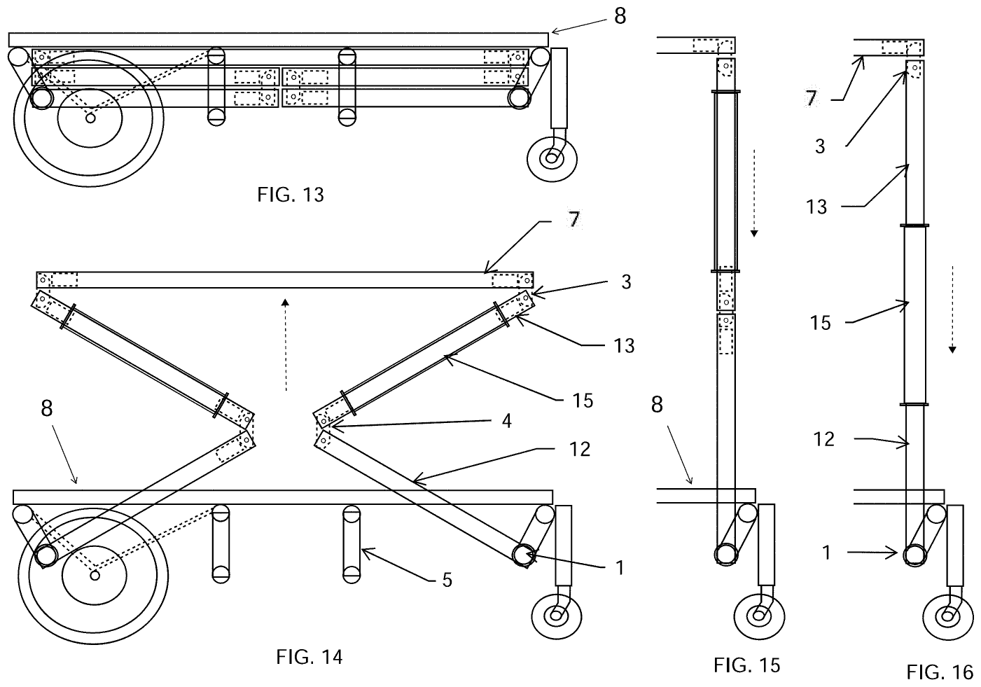

Referring to FIGS. 13 through 20, the hand cart 90 can include a cradle 5 disposed below a main frame 8 thereof. Thus, the hard cart 90 can be used like a conventional hand cart without the vertical support rail system 92 hindering its use. Inside the cradle 5, adjacent the plane of the hand cart as defined by the main frame 8, a user may access the top rail 7 of the vertical support rail system 92. In a single, upward motion, the user can life the top rail 7, causing the center pivoting rail 13 and the bottom pivoting rail 12 to unfold, as shown in FIG. 14. The cradle 5 may be positioned closer to one lengthwise side of the hand cart, as shown in the Figures. In some embodiments, the cradle 5 may be disposed along a central portion of the hand cart. In still other embodiments, the cradle 5 may be two cradles, each positioned adjacent each lengthwise edge of the hand cart. In this embodiment, one or two sets of vertical support rail systems may be raised from the hand cart in the hand cart configuration to convert it to a panel cart configuration.

As can be seen, the vertical support rail system 92 is a single, fully integrated component of the convertible cart. As used herein, the term “single, fully integrated component” is defined as a component that is attached to the convertible cart and is one integral part. It should be understood that a “single, fully integrated component” may be formed from various individual parts (such as, in this case, the top rail 7, the bottom pivoting rail 12, the center pivoting rail 13, and the hinges 3, 4, for example), these parts are connected together and designed not to separate during use thereof in converting between the hand cart and the panel cart configurations.

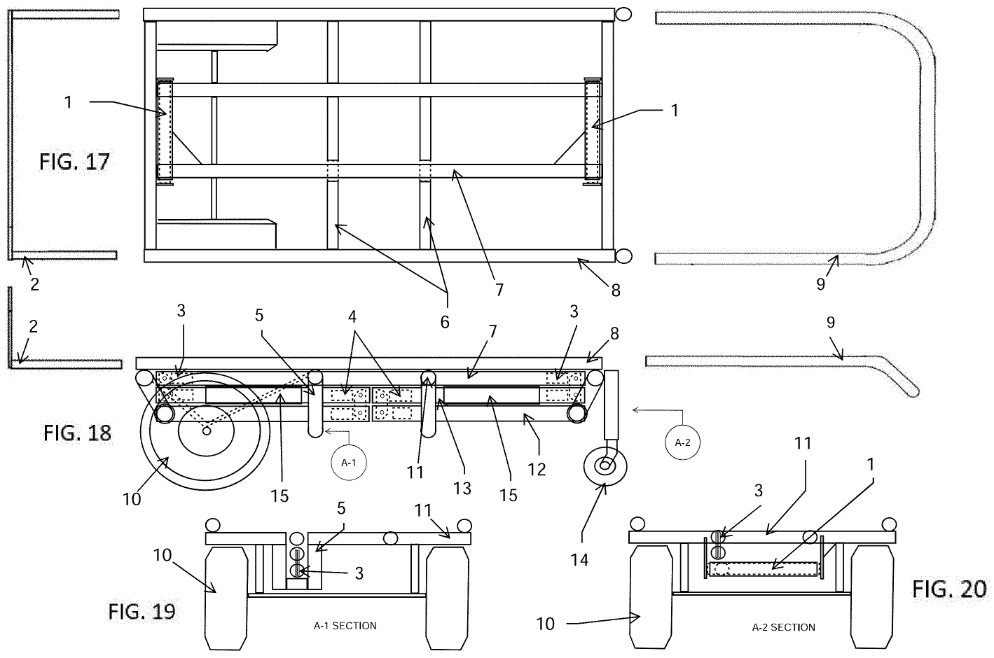

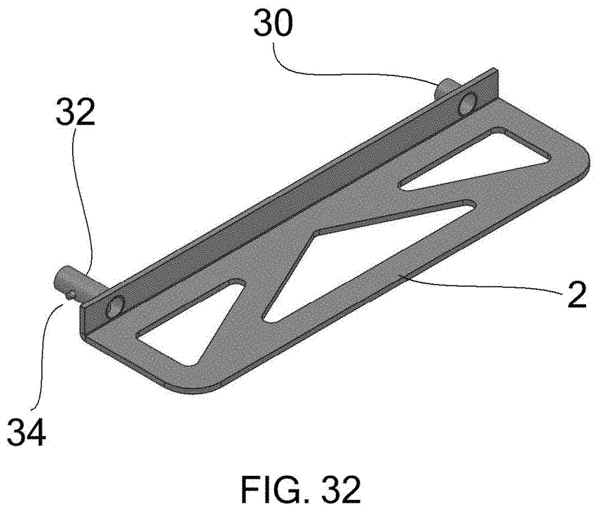

In some embodiments, the tongue 2 may be removable, as shown in FIG. 17 and slid into the cross frame 11 to create a stop for panels when in the panel cart configuration. In other embodiments, as shown in FIGS. 21 through 24, the tongue 2 may pivot from the hand cart configuration into the panel cart configuration. In this embodiment, as shown in FIG. 32, the tongue may include two attachment pins 30, 32 generally coplanar with tongue, with one pin longer than the other. The tongue may be lifted to remove the shorter attachment pin 30, permitting the tongue to pivot on the longer attachment pin 32. The main frame 8 may include a receiver for the shorter pin, to lock the tongue into the panel cart configuration. The longer attachment pin 32 can include a stop 34 to prevent the entire removal of the tongue, thereby simplifying the transitioning without creating loose, separated parts.

The handle 9 can be removable from an end of the hand cart, opposite the tongue 2, to move the handle 9 from a handle usable in the hand cart configuration, into a handle usable in the panel cart configuration by moving the handle from being generally parallel to the main frame 8, to a position generally perpendicular to the main frame 8. The handle, in this configuration, can be positioned to span a short lengthwise side in the panel cart configuration. This configuration is similar to conventional hand carts that can be converted into a flat cart by moving the handle 90 degrees. In other embodiments, the handle may be moved to provide an additional panel supporting member, by positioning the handle to be at an angle, generally 90 degrees, from the plane of the main frame 8, where the handle spans along a lengthwise direction of the panel cart. This configuration is shown, for example, in FIGS. 25 through 28.

It should be noted that the re-positioning of the handle, as discussed above, is not required to change from the hand cart configuration to the panel cart configuration, as movement of the tongue and lifting of the top rail 7 to form the vertical support rail system 92 is all that is needed to create the panel cart.

One example of the use of the convertible hand truck, according to an exemplary embodiment of the present invention, is described. With the hand truck 90 in the horizontal position, the user can reposition the tongue from the hand truck position (along the shorter length side of the hand truck) to the panel cart position (along a portion of the longer length side of the hand truck). The user can then lift the top rail 7, the bottom pivoting rail 12 and the center pivoting rail 13 to extend to the vertical position of the vertical support rail system 92 by pivoting the bottom pivoting rail 12 on the main pivoting hinge rails 1. The sliding support handle 15 can slide down to connect the bottom pivoting rail 12 and the center pivoting rail 13, thereby locking the two into a 180-degree configuration. The top rail 7, and the center pivoting rail 13, can be locked into a 90-degree angle to each other because the bottom pivoting rail 12 can be stopped from further forward motion by the frame of the hand truck. These components create a vertical support rail system 92 to allow objects such as plywood panels, mattresses, doors and windows to lean against it.

The systems' parts are from off the shelf parts or parts that can be made by simple machining. The system can be assembled by anyone experienced in welding and parts machining. It can be created by welding and/or bolting the following metal tubing and machined parts together. The tubing components may be made from solid or hollow tubing members having any geometric or non-geometric shape, such as round hollow tubing, square hollow tubing, or the like, or combinations thereof.

The assembly of the system can be accomplished by various methods as may be known and understood in the art. In some embodiments, the assembly may be realized by welding and/or bolting together the components listed and shown in the drawings starting with the upper support rail 7, connected to two 0 to 90-degree link hinges 3 located on each end that are connected to each of the center support rails 13, which are then connected to each of two 0 to 180-degree link hinges 4, which are then connected to two lower support rails 12, which have a lower section of rails attached at 90 degrees that rotate around the main pivoting hinge rails 1. When the system is in the closed position, the assembly rests in the two under carriage cradles 5. When the system is in the open position the two sliding handle connector rails 15 slide, from a first position on the center support rails 13, half of their length to partially cover the two lower support rails 12, thereby locking the two rails in a 180 position.

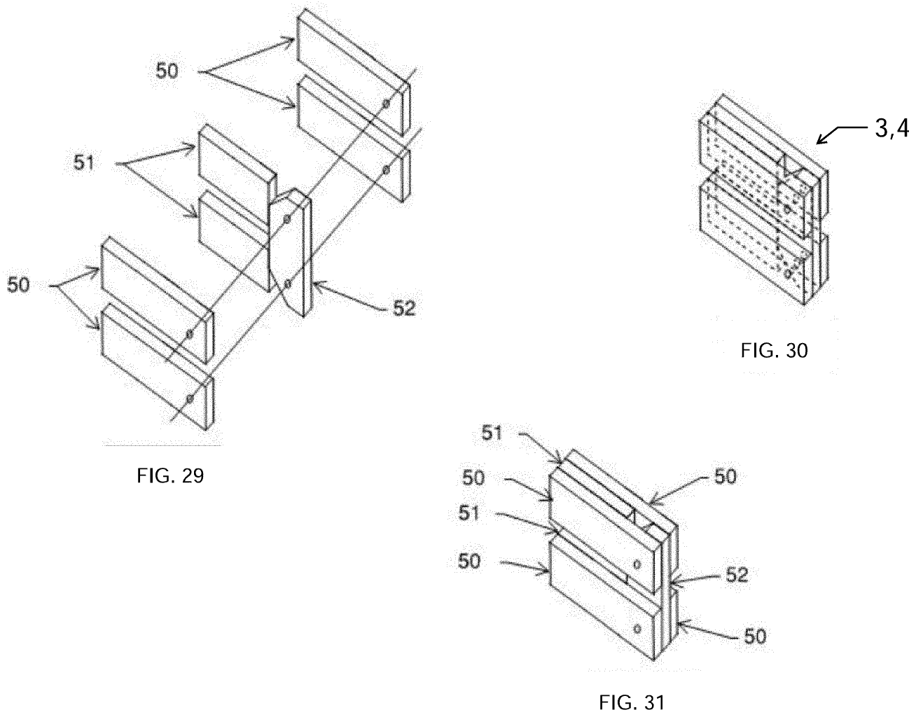

To allow the rails 7, 13, 12 to pivot 180 degrees, link hinges are used. The link hinge provides multiple pivot points to create a space between the two pivot points as seen in FIG. 13. The link hinge assembly is composed of link hinges as seen in FIGS. 29, 30 and 31 slid into the ends of the rails. To reduce the parts required, an alternate method for creating the hinge would be to compress and then drill the end of the rail to receive the hinge pin and link. Both assemblies require machining to fit into the sliding handle 15. Of course, other methods for providing link hinges, as may be known in the art, are contemplated for use in various embodiments of the present invention.

In summary, the present invention provides a plurality of improvements to hand-trucks, carts and dollies that convert to panel-carts, including the folding support rail systems for improving the operational efficiency of the center rails that support panels and other objects during transport. The rail system of the present invention avoids the creation of loose parts, unlike that of conventional systems. The folding support rail system unfolds from the closed position to the open position and then back again in one motion by the operator. The folding support rail system is unique in its application of the hand truck to panel cart conversion in ease of operation. The conventional folding support rail system requires several operator motions and movements to extend, then lock into the open position as shown in FIGS. 5 and 6. The conventional folding support rail system is confusing to the first-time user and has several loose parts that could be lost. Therefore, it would be desirable to have a single motion folding support rail system to convert the hand truck into a panel cart as provided by embodiments of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A convertible cart, comprising:
a main frame defining a main frame perimeter and a main frame plane, the main frame plane defining a lengthwise direction and a widthwise direction;
a set of main wheels extending at least a portion below the main frame plane;
a cradle extending below the main frame plane; and
a vertical support rail system disposed in the cradle when the convertible cart is in a hand cart configuration, wherein
the vertical support rail system is configured to be lifted from the cradle to extend above the main frame plane when the convertible cart is in a panel cart configuration.

2. The convertible cart of claim 1, wherein the vertical support rail system is a single, fully integrated component of the convertible cart.

3. The convertible cart of claim 1, wherein the vertical support rail system is disposed below a plane of the main frame in the hand cart configuration.

4. The convertible cart of claim 1, wherein the vertical support rail system includes a top rail hingedly connected with a first hinge member at ends thereof to a first end of first and second center pivoting rails, wherein a second, opposite end of the first and second center pivoting rails connect with a second hinge member to a first end of respective first and second bottom pivoting rails, wherein a second, opposite end of the first and second bottom pivoting rails pivotably attach to a main pivoting hinge rail.

5. The convertible cart of claim 4, wherein the first hinge member is 90-degree hinge member.

6. The convertible cart of claim 4, wherein the second hinge member is a 180-degree hinge member.

7. The convertible cart of claim 4, further comprising first and second sliding support handles fixing the second hinge member to cause the bottom and center pivoting rails to align in a substantially linear manner when the convertible cart is in a panel cart configuration.

8. The convertible cart of claim 7, wherein the first and second sliding support handles span over the second hinge member and a portion of respective first and second bottom and center pivoting rails when the convertible cart is in the panel cart configuration.

9. The convertible cart of claim 1, further comprising a tongue member, wherein the tongue member is convertible between the hand cart configuration, wherein the tongue member extends along the widthwise direction of the main frame, and the panel cart configuration, wherein the tongue member extends along the lengthwise direction of the main frame.

10. The convertible cart of claim 9, wherein the tongue member is rotatable about an axis, without separation from the main frame, to convert between the hand cart configuration and the panel cart configuration.

11. The convertible cart of claim 10, wherein the tongue member includes a first attachment pin and a second, longer attachment pin extending therefrom, the second, longer attachment pin providing the axis for the tongue member to rotate.

12. The convertible cart of claim 1, further comprising a handle extending from an end of the main frame, the handle having a grip portion extending in the widthwise direction when the convertible cart is in the hand cart configuration.

13. The convertible cart of claim 12, wherein the handle is removable from the main frame and reinsertable into the main frame to extend substantially perpendicular to the main frame plane when the convertible cart is in the panel cart configuration.

14. The convertible cart of claim 13, wherein the grip portion extends in the widthwise direction.

15. The convertible cart of claim 13, wherein the grip portion extends in the lengthwise direction.

16. A convertible cart, comprising:
a main frame defining a main frame perimeter and a main frame plane, the main frame plane defining a lengthwise direction and a widthwise direction;
a set of main wheels extending at least a portion below the main frame plane;
a cradle extending below the main frame plane;
a vertical support rail system disposed in the cradle when the convertible cart is in a hand cart configuration; and
a tongue member, wherein the tongue member is convertible between the hand cart configuration, wherein the tongue member extends along the widthwise direction of the main frame, and the panel cart configuration, wherein the tongue member extends along the lengthwise direction of the main frame, wherein
the vertical support rail system is configured to be lifted from the cradle to extend above the main frame plane when the convertible cart is in a panel cart configuration, and
the vertical support rail system is a single, fully integrated component of the convertible cart.

17. The convertible cart of claim 16, wherein the tongue member is rotatable about an axis, without separation from the main frame, to convert between the hand cart configuration and the panel cart configuration.

18. A convertible cart, comprising:
a main frame defining a main frame perimeter and a main frame plane, the main frame plane defining a lengthwise direction and a widthwise direction;
a set of main wheels extending at least a portion below the main frame plane;
a cradle extending below the main frame plane;
a vertical support rail system disposed in the cradle when the convertible cart is in a hand cart configuration;
a handle extending from an end of the main frame, the handle having a grip portion extending in the widthwise direction when the convertible cart is in the hand cart configuration; and
a tongue member, wherein the tongue member is rotatable about an axis, without separation from the main frame, to convert between the hand cart configuration and the panel cart configuration, wherein, in the hand cart configuration, the tongue member extends along the widthwise direction of the main frame, and the panel cart configuration, the tongue member extends along the lengthwise direction of the main frame, wherein
the vertical support rail system is configured to be lifted from the cradle to extend above the main frame plane when the convertible cart is in a panel cart configuration, and
the vertical support rail system is a single, fully integrated component of the convertible cart.

19. The convertible cart of claim 18, wherein the handle is removable from the main frame and reinsertable into the main frame to extend substantially perpendicular to the main frame plane when the convertible cart is in the panel cart configuration.
